(19) United States
(12) Patent Application Publication
(10) Pub. No.: US 2015/0240559 A1
(43) Pub. Date: Aug. 27, 2015

(54) WINDOW BLIND WITH CARRIAGE

(71) Applicant: NIEN MADE ENTERPRISE CO., LTD., Taichung City (TW)

(72) Inventor: LIN CHEN, Taichung City (CN)

(21) Appl. No.: 14/619,850

(22) Filed: Feb. 11, 2015

(30) Foreign Application Priority Data
Feb. 27, 2014 (CN) 201420085483.5

(51) Int. Cl. E06B 9/38

(52) U.S. Cl. CPC E06B 9/38

(57) ABSTRACT

A window blind with carriage has a carriage provided in a headrail, wherein the carriage is movable along the headrail to bring at least one cord, and to move a bottom rail up and down relative to the headrail between an expanding position and a collapsing position. A retarding unit is further provided in the headrail, wherein the retarding unit provides a retarding force to the carriage to stop the carriage when the bottom rail arrives at the expanding position, which ensures that the bottom rail stops at a predetermined position without rebounding when the window blind is fully expanded.

The current application claims a foreign priority to the patent application of China No. 201420085483.5 filed on Feb. 27, 2014.

### BACKGROUND OF THE INVENTION

1. Technical Field

The present invention relates generally to a window blind, and more particularly to a window blind with a carriage.

2. Description of Related Art

A conventional window blind which automatically winds up itself basically includes a headrail, a bottom rail, and a slat assembly connected to the headrail and the bottom rail therebetween. Typically, this type of window blind uses a reel in accordance with a carriage to move the bottom rail towards or away from the headrail through a cord, and the slat assembly can be opened or closed accordingly.

For a cellular blind, its slat assembly has a cellular structure, which contains multiple rooms therein. Due to such structure, a cellular blind occupies less space in collapsed status, and the slat assembly is extendable and flexible. However, the bottom rail of a cellular blind tends to rebound when the slat assembly is just fully expanded, which is undesirable. To avoid this situation, some manufacturers apply a counterweight design on the bottom rail, which provides extra weight to suppress the rebounding. But such counterweight design makes the bottom rail stay at a lower-than-predetermined position when the cellular blind is collapsed. In addition, since lightweight window blinds are more preferable for common users, counterweight design applied on the bottom rail seems not a good idea.

### BRIEF SUMMARY OF THE INVENTION

In view of the above, the primary objective of the present invention is to provide a window blind, which is lightweight, and when the window blind is expanded, the bottom rail thereof can be precisely positioned as predetermined.

The present invention provides a window blind with carriage, which includes a carriage provided in a headrail, wherein the carriage is movable along the headrail between a start position and an end position to bring at least one cord, and to move a bottom rail up and down relative to the headrail between a collapsing position and an expanding position. The window blind is characterized in that a retarding unit is further provided in the headrail, wherein the retarding unit provides a retarding force to the carriage to stop the carriage after the carriage is moved to a predetermined position while the carriage is being moved toward the end position.

In an embodiment, the window blind further includes a reel device and a cord holder respectively provided at two ends of the headrail, wherein the carriage is between the reel device and the cord holder, and so are the start position and the end position; wherein the start position is near the reel device, while the end position is near the cord holder; the predetermined position is between the start position and the end position; the cord is wound between the reel device, the carriage, and the cord holder with an end thereof extending out of the headrail to be fixed at the bottom rail.

In an embodiment, a distance between the predetermined position and the end position is no greater than two thirds of a distance between the start position to the end position.

In an embodiment, the retarding unit includes an elastic plate provided between the predetermined position and the end position; at least one end of the elastic plate is fixed at the headrail; a middle portion of the elastic plate is bulge; a part of the carriage touches the middle portion of the elastic plate to deform the elastic plate after the carriage is moved to the predetermined position while the carriage is being moved toward the end position.

In an embodiment, the headrail has at least one positioning hole near the cord holder; an end of the elastic plate is inserted into the positioning hole to fix the elastic plate at the headrail.

In an embodiment, an inner wall of the headrail has two corresponding tracks, each of which has a upper confining plane and a lower confining plane; the carriage includes at least two wheels respectively received in one of the tracks; each of the wheels is confined by the corresponding upper confining plane and the corresponding lower confining plane together, and is only movable along the corresponding track.

In an embodiment, another end of the elastic plate has a slot hole; a positioning pin goes through the slot hole to be fixed at the headrail, and therefore the elastic plate is deformable and the another end of the elastic plate is movable along the slot hole when exerted with a force.

When the window slat is just fully expanded, the carriage is prevented from being moved due to a retarding force applied to the carriage, and therefore the bottom rail stays at a predetermined position without rebounding.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a exploded view of a first preferred embodiment of the present invention;

FIG. 2 is a front view of the first preferred embodiment of the present invention, showing the carriage is near the reel device;

FIG. 3 is a front view of the first preferred embodiment of the present invention, showing the bottom of the carriage abuts against the elastic plate;

FIG. 4 is a partial perspective view of the first preferred embodiment of the present invention, showing the bottom of the carriage abuts against the elastic plate;

FIG. 5 is a exploded view of a second preferred embodiment of the present invention;

FIG. 6 is a front view of the second preferred embodiment of the present invention, showing the carriage is near the reel device; and

FIG. 7 is a front view of the second preferred embodiment of the present invention, showing the bottom of the carriage abuts against the elastic plate.

### DETAILED DESCRIPTION OF THE INVENTION

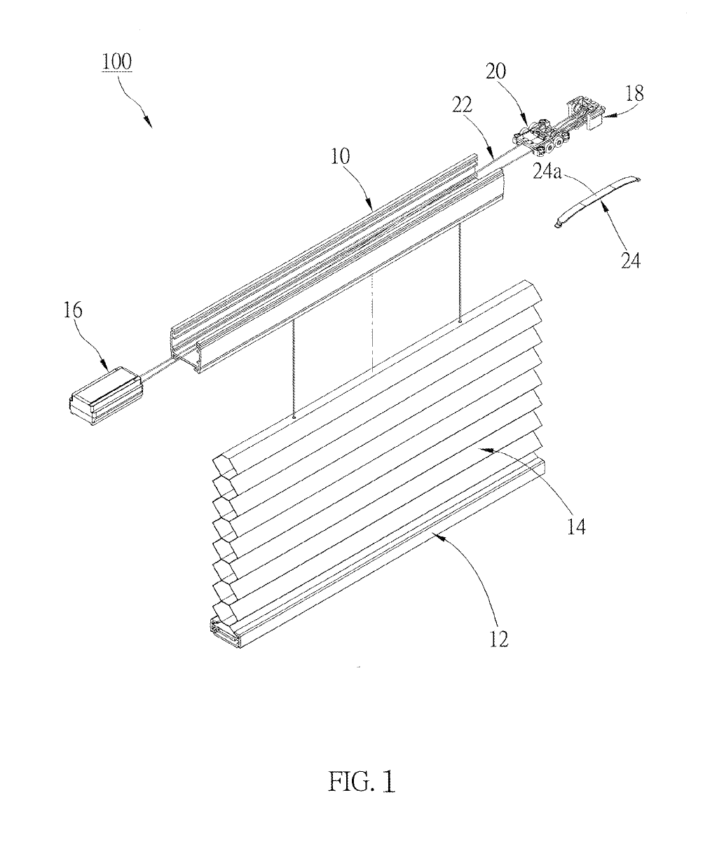

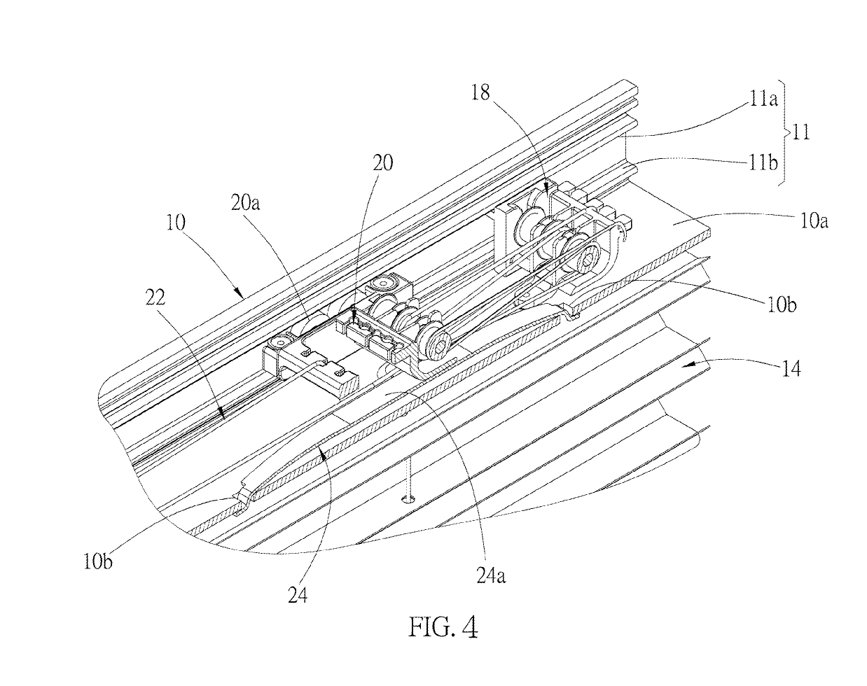

As shown in FIG. 1 to FIG. 4, a window blind 100 of the first preferred embodiment of the present invention includes a headrail 10, a bottom rail 12, and a slat assembly 14. In the first preferred embodiment, the slat assembly 14 has a cellular structure, and is connected to the headrail 10 and the bottom rail 12. The bottom rail 12 is not applied with additional counterweight design, and therefore the window blind 100 can be more lightweight.

The window blind 100 further includes a reel device 16, a cord holder 18, and a carriage 20 provided in the headrail 10. The reel device 16 and the cord holder 18 are respectively located at two ends of the headrail 10, while the carriage 20 is provide between the reel device 16 and the cord holder 18. An inner wall of the headrail 10 has two corresponding tracks 11, wherein each of the tracks 11 has an upper confining plane 11a and a lower confining plane 11b. The carriage 20 includes a plurality of wheels 20a which are respectively received in one of the tracks 11, whereby the carriage 20 does not contact a bottom plate 10a of the headrail 10. Each of the wheels 20a is confined by the upper confining plane 11a and the lower confining plane 11b together, which restricts the carriage 20 to be moved along the track 11 between a start position P1 and an end position P2. More specifically, the start position P1 and the end position P2 are both between the reel device 16 and the cord holder 18, wherein the start position P1 is near the reel device 16, and the end position P2 is near the cord holder 18.

A cord 22 is further provided to be wound between the reel device 16 and the cord holder 18, and is wound around the carriage 20 with two ends of the cord 22 respectively extending out of the headrail 10, going through the slat assembly 14, and then being fixed at the bottom rail 12. By controlling the cord 22 with the reel device 16, the carriage 20 can be moved along the headrail 10 between the start position P1 and the end position P2. Meanwhile, when the cord 22 is pulled out of the reel device 16 or is wound and received therein, the bottom rail 12 is moved up and down relative to the headrail 10 between a collapsing position P3 and an expanding position P4, and the slat assembly 14 can be expanded or collapsed correspondingly.

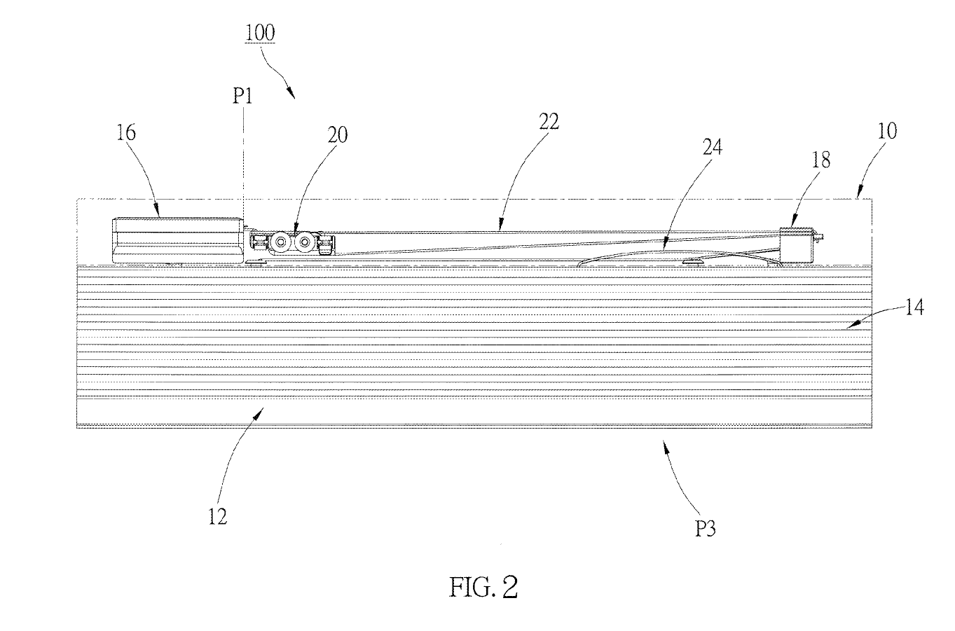

The window blind 100 further includes a retarding unit, which is a long, narrow, and thin elastic plate denoted as a leaf spring 24 in the first preferred embodiment. The leaf spring 24 is provided near the cord holder 18 with two ends thereof respectively inserted into two positioning holes 10b at the bottom plate 10a of the headrail 10, wherein a middle portion 24a of the leaf spring 24 is forced to bulge upward. In FIG. 2, the carriage 20 is located near the reel device 16 (i.e., the carriage 20 stops at the start position P1). At this time, the slat assembly 14 is collapsed, for the bottom rail 12 is located at the collapsing position P3. Since the bottom rail 12 is not applied with an additional counterweight design, the bottom rail 12 can arrive at the collapsing position P3 exactly, instead of staying at a lower-than-expected position.

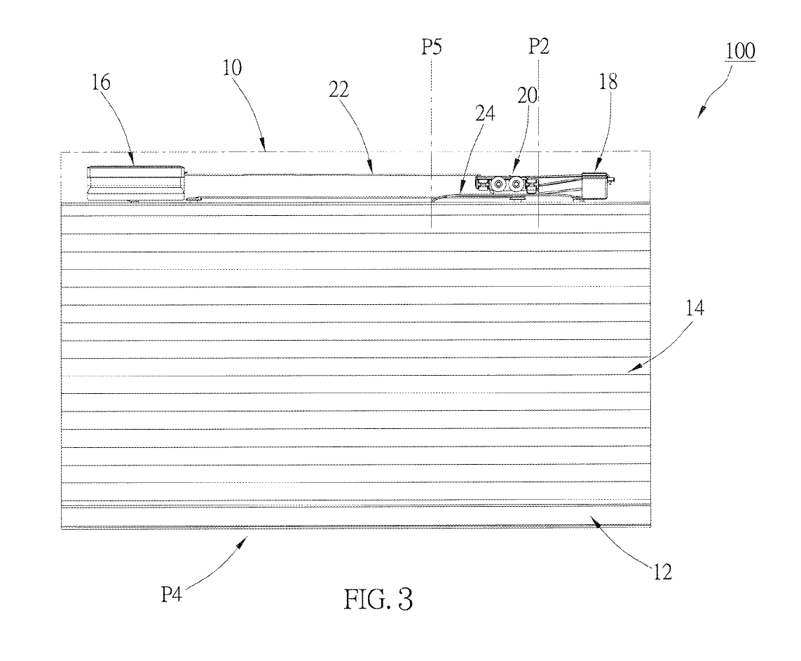

While the bottom rail 12 is moved downward to expand the slat assembly 14, the carriage 20 is moved toward the cord holder 18. Once the carriage 20 arrives at a predetermined position P5 between the start position P1 and the end position P2, the carriage 20 starts to abut against the leaf spring 24 with a bottom thereof. As shown in FIG. 3, if the carriage 20 is continuously moved toward the end position P2, the carriage 20 forces the leaf spring 24 to deform, and the deformed leaf spring 24 provides an upward retarding force to the carriage 20 in return, which not only reduces the moving speed of the carriage 20, but also generates a retention effect for the carriage 20 when it arrives at the middle portion 24a of the leaf spring 24. In this way, the retarding force effectively suppresses the flexibility of the slat assembly 14 caused by the cellular structure, and therefore the bottom rail 12 can be guaranteed to directly stop at the expanding position P4 without rebounding. As a result, the carriage 20 is prevented from being moved arbitrarily, and the slat assembly 14 can be fully expanded. Though the retarding unit is a leaf spring in the first preferred embodiment, it can also be different components in practice, as long as the retarding unit bulges upward from the bottom plate 10a of the headrail 10. For example, instead of the metal leaf spring, the elastic plate can be made of plastic, too. In another embodiment, the elastic plate can be fixed with only one end thereof inserted into the positioning hole 10b near the reel device 16. Alternatively, the elastic plate and the headrail can be also made integrally with a bulge middle portion formed by stamping, which similarly provides the same retention effect.

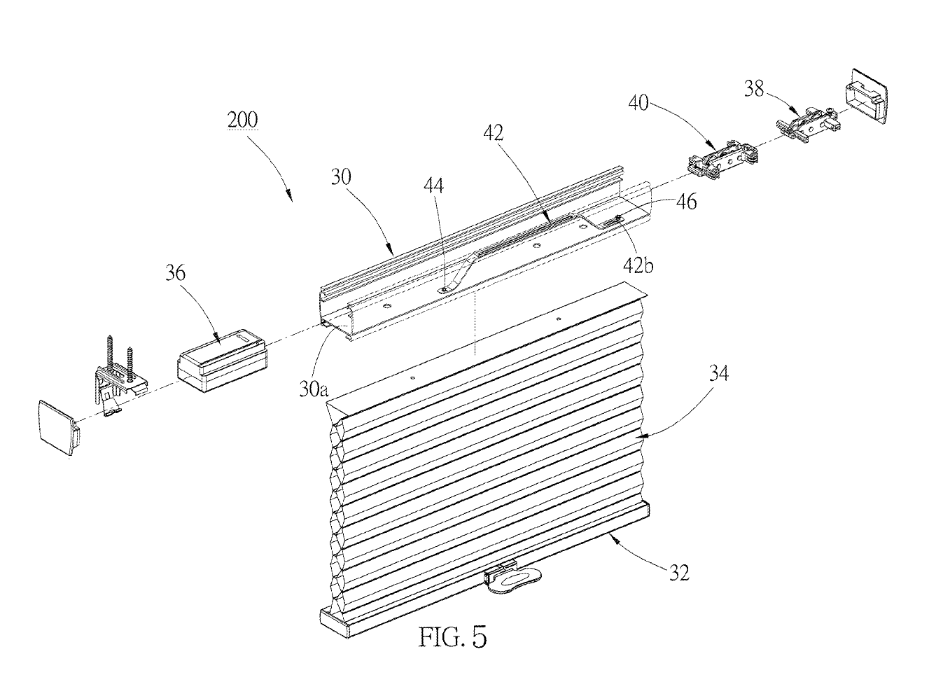

In addition, as shown in FIG. 5 to FIG. 7, a window blind 200 of the second preferred embodiment of the present invention also includes a headrail 30, a bottom rail 32, a slat assembly 34, a reel device 36, a cord holder 38, and a carriage 40 as the window blind 100 of the first preferred embodiment. Again, the slat assembly 34 has a cellular structure, and the bottom rail 32 has no additional counterweight design applied thereon. Furthermore, the retarding unit of the window blind 200 is also an elastic plate as an example, which is denoted as a leaf spring 42 with a bulge middle portion 42a herein. The difference between the window blinds 100, 200 of the first and the second preferred embodiments is that an end of the leaf spring 42 is fixed at the bottom plate 30a of the headrail 30 with a bolt 44, while another end of the leaf spring 42 has a slot hole 42b. A positioning pin, which is a bolt 46 as an example, goes through the slot hole 42b to be screwed into the bottom plate 30a, wherein the bolt 46 does not press onto the leaf spring 42, and therefore the leaf spring 42 can be deformed and the another end of the leaf spring 42 is movable along the slot hole 42b while being exerted with a force.

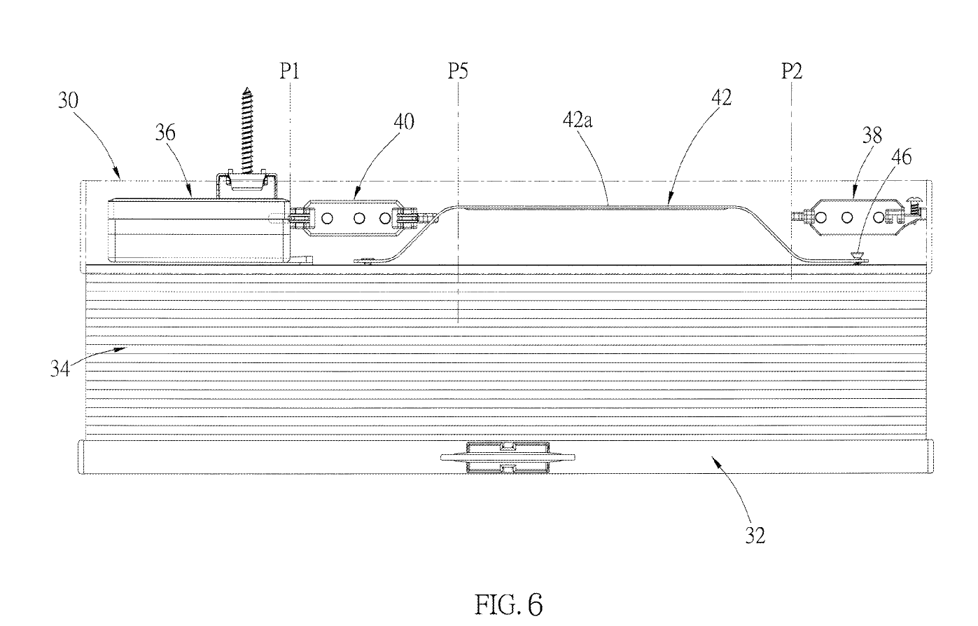

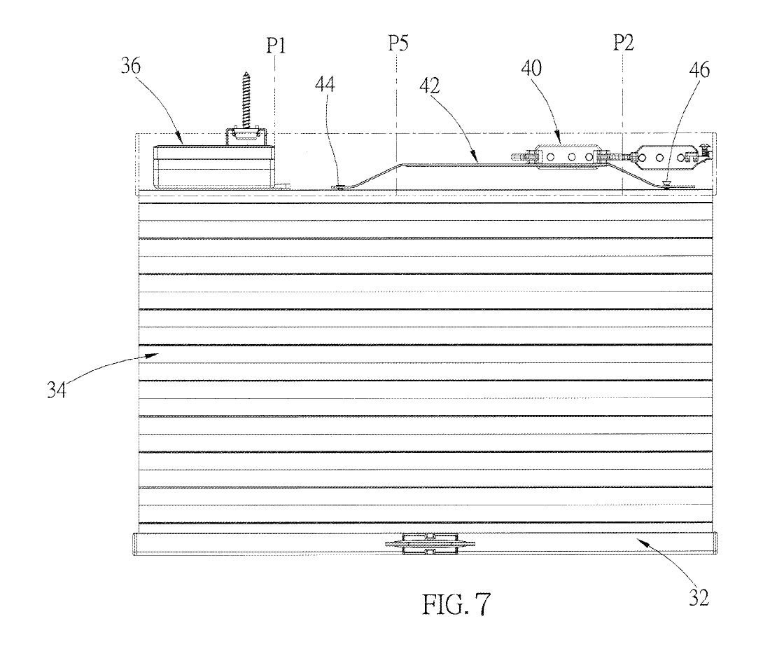

It is worth mentioning that the leaf spring 42 of the second preferred embodiment is longer than the leaf spring 24 of the first preferred embodiment, and its middle portion 42a is bulge at a different part. In more details, for the position where the carriage 40 is, a distance between the predetermined position P5 and the end position P2 is no greater than two thirds of a distance between the start position P1 and the end position P2. In this way, during the slat assembly 34 is being expanded, and the carriage 40 is being moved from the start position P1 shown as FIG. 6 to the end position P2 shown as FIG. 7, the carriage 40 abuts against the leaf spring 42 soon (i.e., the carriage 40 arrives at the predetermined position P5), which deforms the leaf spring 42. The continuously upward retarding force is exerted on the carriage 40 to generate friction between the carriage 40 and the leaf spring 42, which reduces the moving speed. Furthermore, once the slat assembly 34 is no longer pulled or expanded, the carriage 40 has a retention effect as well. Similarly, the window blind 200 of the second preferred embodiment is able to prevent the bottom rail 32 from rebounding when the slat assembly 34 is expanded.

It must be pointed out that the embodiments described above are only some preferred embodiments of the present invention. All equivalent structures which employ the concepts disclosed in this specification and the appended claims should fall within the scope of the present invention.

What is claimed is:

1. A window blind with carriage comprising a carriage provided in a headrail, wherein the carriage is movable along the headrail between a start position and an end position to bring at least one cord, and to move a bottom rail up and down relative to the headrail between a collapsing position and an expanding position; the window blind is characterized in:
comprising a retarding unit provided in the headrail, wherein the retarding unit provides a retarding force to the carriage to stop the carriage after the carriage is moved to a predetermined position while the carriage is being moved toward the end position.

2. The window blind with carriage of claim 1, further comprising a reel device and a cord holder respectively provided at two ends of the headrail, wherein the carriage is between the reel device and the cord holder, and so are the start position and the end position; wherein the start position is near the reel device, while the end position is near the cord holder; the predetermined position is between the start position and the end position; the cord is wound between the reel device, the carriage, and the cord holder with an end thereof extending out of the headrail to be fixed at the bottom rail.

3. The window blind with carriage of claim 2, wherein a distance between the predetermined position and the end position is no greater than two thirds of a distance between the start position to the end position.

4. The window blind with carriage of claim 2, wherein the retarding unit includes an elastic plate provided between the predetermined position and the end position; at least one end of the elastic plate is fixed at the headrail; a middle portion of the elastic plate is bulge; a part of the carriage touches the middle portion of the elastic plate to deform the elastic plate after the carriage is moved to the predetermined position while the carriage is being moved toward the end position.

5. The window blind with carriage of claim 4, wherein the headrail has at least one positioning hole near the cord holder; an end of the elastic plate is inserted into the positioning hole to fix the elastic plate at the headrail.

6. The window blind with carriage of claim 3, wherein an inner wall of the headrail has two corresponding tracks, each of which has a upper confining plane and a lower confining plane; the carriage includes at least two wheels respectively received in one of the tracks; each of the wheels is confined by the corresponding upper confining plane and the corresponding lower confining plane together, and is only movable along the corresponding track.

7. The window blind with carriage of claim 4, wherein another end of the elastic plate has a slot hole; a positioning pin goes through the slot hole to be fixed with the headrail, and therefore the elastic plate is deformable and the another end of the elastic plate is movable along the slot hole when exerted with a force.
